(19) United States
(12) Patent Application Publication
(10) Pub. No.: US 2020/0209874 A1
(43) Pub. Date: Jul. 2, 2020

(54) COMBINED VIRTUAL AND REAL ENVIRONMENT FOR AUTONOMOUS VEHICLE PLANNING AND CONTROL TESTING

(71) Applicant: SF Motors, Inc., Santa Clara, CA (US)

(72) Inventors: Jhenghao Chen, Santa Clara, CA (US); Fan Wang, Santa Clara, CA (US); Yifan Tang, Santa Clara, CA (US); Chen Bao, Santa Clara, CA (US)

(73) Assignees: Chongqing Jinkang New Energy Vehicle, Ltd., Chongqing (CN); SF Motors, Inc., Santa Clara, CA (US)

(21) Appl. No.: 16/237,548

(22) Filed: Dec. 31, 2018

(51) Int. Cl. G05D 1/02; G05D 1/00; G06K 9/00; G06T 19/00; G06F 17/50

(52) U.S. Cl. CPC G05D 1/0221; G05D 1/0088; G06K 9/00798; G05D 2201/0213; G06T 19/006; G06F 17/5009; G06K 9/00805

(57) ABSTRACT

A combined virtual and real environment for autonomous vehicle planning and control testing. An autonomous vehicle is operated in a real environment where a planning module and control module operate to plan and execute vehicle navigation. Simulated environment elements, including simulated image and video detected objects, simulated radar detected objects, simulated lane lines, and other simulated elements detectable by radar, lidar, camera, and any other vehicle perception systems, are received along with real-world detected elements. The simulated and real-world elements are combined and processed to by the autonomous vehicle data processing system. Once processed, the autonomous vehicle plans and executes navigation based on mixed real-world and simulated data in the same way. By adding simulated data to real data, the autonomous vehicle systems may be tested in hypothetical situations in a real-world environment and conditions.

### BACKGROUND

Autonomous driving technology is growing rapidly with many features implemented in autonomous vehicles. Testing automated vehicles can be expensive and inefficient. To test automated vehicle systems in a purely simulated environment is convenient, as it all occurs on one or more computing machines, but a purely simulated environment will not perfectly match the results obtained in a real-world environment. Some locations exist for testing autonomous vehicles, but they are very expensive and limited in availability. What is needed is an improved method for testing autonomous vehicles.

### SUMMARY

The present technology, roughly described, provides a combined virtual and real environment for autonomous vehicle planning and control testing. An autonomous vehicle is operated in a real environment where a planning module and control module operate to plan and execute vehicle navigation. Simulated environment elements, including simulated image and video detected objects, simulated radar detected objects, simulated lane lines, and other simulated elements detectable by radar, lidar, camera, and any other vehicle perception systems, are received along with real world detected elements. The simulated and real-world elements are combined and processed to by the autonomous vehicle data processing system. Once processed, the autonomous vehicle plans and executes navigation based on mixed real world and simulated data in the same way. By adding simulated data to real data, the autonomous vehicle systems may be tested in hypothetical situations in a real-world environment and conditions.

In embodiments, a system for operating an autonomous vehicle based on real world and virtual perception data includes a data processing system comprising one or more processors, memory, a planning module, and a control module. The data processing system receives real world perception data from real perception sensors, receives simulated perception data, combines the real world perception data and simulated perception data, and generates a plan to control the vehicle based on the combined real world perception data and simulated perception data, the vehicle operating in a real world environment based on the plan generated from the real world perception data and simulated perception data.

In embodiments, a non-transitory computer readable storage medium includes a program, the program being executable by a processor to perform a method for operating an autonomous vehicle based on real world and virtual perception data. The method includes receiving real world perception data from real perception sensors, receiving simulated perception data, combining the real world perception data and simulated perception data, and generating a plan to control the vehicle based on the combined real world perception data and simulated perception data, the vehicle operating in a real world environment based on the plan generated from the real world perception data and simulated perception data.

In embodiments, a method is disclosed for operating an autonomous vehicle based on real world and virtual perception data. The method includes receiving, by a data processing system stored in memory and executed by one or more processors, real world perception data from real perception sensors, and receiving, by the data processing system, simulated perception data. The real-world perception data and simulated perception data is combined, and a plan is generated to control the vehicle based on the combined real-world perception data and simulated perception data, wherein the vehicle operates in a real-world environment based on the plan generated from the real-world perception data and simulated perception data.

### BRIEF DESCRIPTION OF FIGURES

FIG. 1 is a block diagram of an autonomous vehicle.

FIG. 2A is a block diagram of a data processing system within a real autonomous vehicle.

FIG. 2B is a block diagram of a data processing system within a virtual autonomous vehicle.

FIG. 2C is a block diagram of a virtual environment module.

FIG. 3 is a method for operating an autonomous vehicle based on real world and virtual environment data.

FIG. 4 is a method for receiving real world perception data.

FIG. 5 is a method for receiving virtual environment perception data.

FIG. 6 is a method for combining and processing real world and virtual environment data.

FIG. 7 is a method for planning a move from a current position to a target position.

FIG. 8 is a method for evaluating and ranking generated trajectories.

FIG. 9 is a method for performing a safety check.

FIG. 9 illustrates a center reference line in a current lane.

FIG. 10 illustrates a vehicle with elements determined from real world perception data.

FIG. 11 illustrates the vehicle of FIG. 10 with elements determined from real world perception data and virtual environment perception data.

FIG. 12 is a block diagram of a computing environment for implementing a data processing system.

### DETAILED DESCRIPTION

The present technology, roughly described, provides a combined virtual and real environment for autonomous vehicle planning and control testing. An autonomous vehicle is operated in a real environment where a planning module and control module operate to plan and execute vehicle navigation. Simulated environment elements, including simulated image and video detected objects, simulated radar detected objects, simulated lane lines, and other simulated elements detectable by radar, lidar, camera, and any other vehicle perception systems, are received along with real world detected elements. The simulated and real-world elements are combined and processed to by the autonomous vehicle data processing system. Once processed, the autonomous vehicle plans and executes navigation based on mixed real world and simulated data in the same way. By adding simulated data to real data, the autonomous vehicle systems may be tested in hypothetical situations in a real-world environment and conditions.

The combination of the real-world perception data and virtual world perception data is performed and processed by a data management system embedded in the autonomous vehicle. In some instances, virtual environment elements are not displayed for a person within the vehicle during operation. Rather, the planning of navigation and control of the vehicle in response to the combined real world and virtual environment perception data is stored and analyzed to determine the performance of the data management system and to tune the accuracy of the planning and control modules of the data management system.

The technical problem addressed by the present technology involves safely and successfully testing an autonomous vehicle in an efficient and accurate manner. Testing autonomous vehicles in a purely simulated environment results in inaccurate results and modeling. Testing autonomous vehicles in a custom-built real-world environment is expensive and impractical for the amount of testing often required to tune autonomous vehicle systems.

The present technology provides a technical solution to the technical problem of testing and tuning planning and control modules of an autonomous vehicle by operating the autonomous vehicle in a real environment based on real world perception data and virtual world perception data. The real-world response to the combined perception data is analyzed and fed back into the system to tune the planning and control modules, providing a safe and efficient method to perform accurate testing of the autonomous vehicle computing systems.

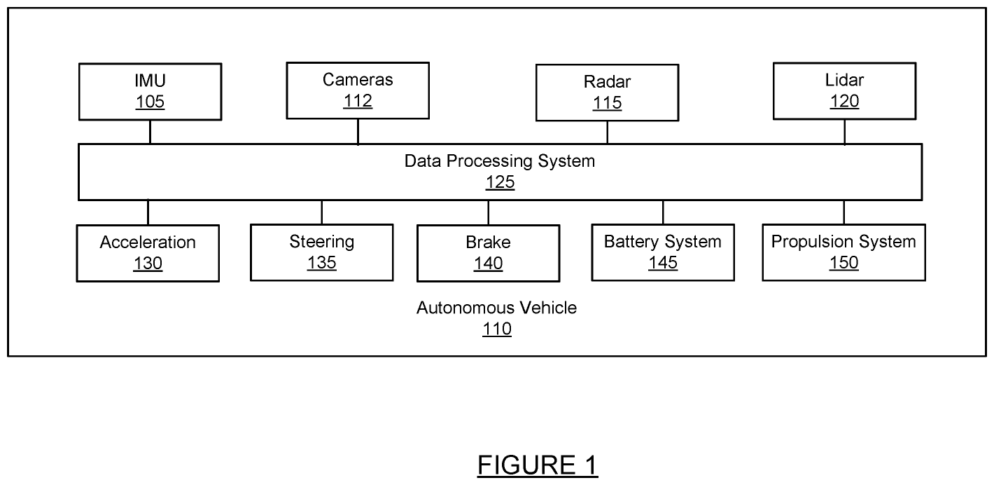

FIG. 1 is a block diagram of an autonomous vehicle. The autonomous vehicle 110 of FIG. 1 includes a data processing system 125 in communication with an inertia measurement unit (IMU) 105, cameras 110, radar 115, and lidar 120. Data processing system 125 may also communicate with acceleration 130, steering 135, breaks 140, battery system 145, and propulsion system 150. The data processing system and the components to communicate with are intended to be exemplary for purposes of discussion. It is not intended to be limiting, and additional elements of an autonomous vehicle may be implemented in a system of the present technology, as will be understood by those of ordinary skill in the art.

IMU 105 may track and measure the autonomous vehicle acceleration, yaw rate, and other measurements and provide that data to data processing system 125.

Cameras 110, radar 115, and lidar 120 may form all or part of a real-world perception component of autonomous vehicle 110. The autonomous vehicle may include one or more cameras 110 to capture visual data inside and outside of the autonomous vehicle. On the outside of the autonomous vehicle, multiple cameras may be implemented. For example, cameras on the outside of the vehicle may capture a forward-facing view, a rear facing view, and optionally other views. Images from the cameras may be processed to detect objects such as streetlights, stop signs, lines or borders of one or more lanes of a road, and other aspects of the environment for which an image may be used to better ascertain the nature of an object than radar. To detect the objects, pixels of images are processed to recognize objects, and singular images and series of images. The processing may be performed by image and video detection algorithms, machine learning models which are trained to detect particular objects of interest, and other techniques.

Radar 115 may include multiple radar sensing systems and devices to detect objects around the autonomous vehicle. In some instances, a radar system may be implemented at one or more of each of the four corners of the vehicle, a front of the vehicle, a rear of the vehicle, and on the left side and right side of the vehicle. The radar elements may be used to detect stationary and moving objects in adjacent lanes as well as in the current lane in front of and behind the autonomous vehicle. Lidar may also be used to detect objects in adjacent lanes, as well as in front of and behind the current vehicle.

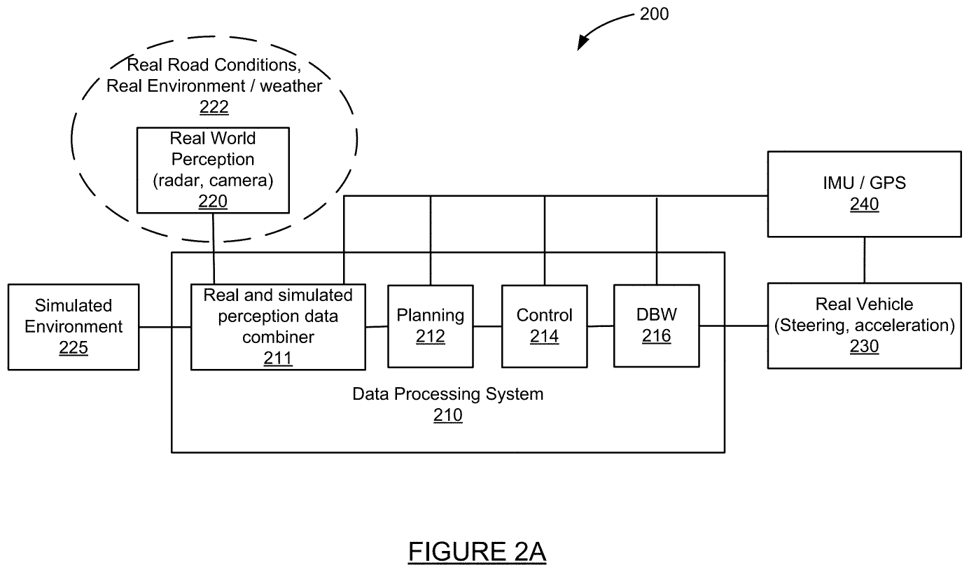

Data processing system 125 may include one or more processors, memory, and instructions stored in memory and executable by the one or more processors to perform the functionality described herein. In some instances, the data processing system may include a planning module, a control module, and a drive-by wire module, as well as a module for combining real world perception data and virtual environment perception data. The modules communicate with each other to receive data from a real-world perception component and virtual environment perception component, plan actions such as lane changes, parking, acceleration, braking, route navigation, and other actions, and generate commands to execute the actions. The data processing system 125 is discussed in more detail below with respect to the system of FIG. 2A.

Acceleration 130 may receive commands from the data processing system to accelerate. Acceleration 130 may be implemented as one or more mechanisms to apply acceleration to the propulsion system 150. Steering module 135 controls the steering of the vehicle, and may receive commands to steer the vehicle from data processing system 135. Brake system 140 may handle braking applied to the wheels of autonomous vehicle 110, and may receive commands from data processing system 125. Battery system 145 may include a battery, charging control, battery management system, and other modules and components related to a battery system on an autonomous vehicle. Propulsion system 150 may manage and control propulsion of the vehicle, and may include components of a combustion engine, electric motor, drivetrain, and other components of a propulsion system utilizing an electric motor with or without a combustion engine.

FIG. 2A is a block diagram of a data processing system within a real autonomous vehicle. Data processing system 210 provides more detail for data processing system 125 of the system of FIG. 1. Data processing system may receive data and information from real-world perception component 220 and simulated environment 225. Real-world perception component 220 may include radar and camera elements, as well as logic for processing the radar and camera output to identify objects of interest, lane lines, and other elements.

Simulated environment 225 may provided simulated, such as for example synthetically generated, modeled, or otherwise created perception data. The perception data may include objects, detected lanes, and other data. The data may be provided in the same format as data provided by real-world perception module 220.

Data from the real-world perception component 220 and simulated environment 225 is received by perception data combiner 211. The real and simulated perception data combiner may receive real-world perception data from real-world perception 220 and simulated perception data from simulated environment 225. The combiner 211 may combine the data, process the data to generate an object list and collection of detected lane lines, and provide the data to planning module 212. In some instances, once the object list and detected lane lines is received by planning module 212, the data is treated the same and there are no differences between processing that involves a real-world element (object, lane line, lane boundary, etc.) or a virtual environment element.

Planning module 212 may receive and process the combined real-world and virtual environment data and information received from the perception data combiner 211 to plan actions for the autonomous vehicle. The actions may include navigating from the center of a lane to an adjacent lane, navigating from a current lane to an adjacent lane, stopping, accelerating, turning, and performing other actions. Planning module 212 may generate samples of trajectories between two lines or points, analyze and select the best trajectory, and provide a best trajectory for navigating from one point to another to control 214.

Control module may receive information from the planning module, such as a selected trajectory over which a lane change should be navigated. Control module 214 may generate commands to be executed in order to navigate a real vehicle along the selected trajectory. The commands may include instructions for accelerating, breaking, and turning to effectuate navigation along the best trajectory.

Drive-by wire module 216 may receive the commands from control 214 and actuate the autonomous vehicle navigation components based on the commands. In particular, drive-by wire 216 may control the accelerator, steering wheel, brakes, turn signals, and other optionally other real-world car components 230 of the autonomous vehicle.

The system of FIG. 2A relates to a data processing system that processes real and simulated perception data to control a real autonomous vehicle. The real vehicle travels in the real world in response to planned actions by the planning module that are carried out by the control module. In some instances, the combined real-world perception data and simulated perception data can be processed and used to plan actions for and control a simulated vehicle rather than a real vehicle.

FIG. 2B is a block diagram of a data processing system within a virtual autonomous vehicle. The system of FIG. 2B includes several elements that are similar to those of the system of FIG. 2, including real world perception 220, simulated environment 225, real and simulated perception data combiner 211, planning 212, and control 214. These elements can operate in similar manner in systems for both a real vehicle and a simulated vehicle. In some instances, the data processing system of FIG. 2A can be implemented on a real vehicle, while the data processing system of FIG. 2B can be implemented in a laboratory, office, or any other location, and is not limited to implementation on an actual vehicle. The real-world perception 220 can be captured from real sensors on a real vehicle. However, the data from the real sensors if not processed on a real vehicle, but somewhere else, such as for example a desktop computer in an office.

In FIG. 2C, drive by wire module 216 may be a simulated module, because the simulated vehicle 260 does not have real steering, acceleration, and braking mechanisms. Rather, the steering, acceleration, and braking mechanisms are simulated. Further, the IMU module which provides acceleration and yaw rate provides simulated data rather than data for a real vehicle.

FIG. 2C is a block diagram of a virtual environment module. The simulated environment of FIG. 2C includes HD map data 252, user defined simulated lanes 254, recorded GPS path data 256, and obstacles 258. The high definition (HD) map data may include data such as lane lines, road borders, mapping data, and other road data. In some instances, one or more sets HD map data can be generated as a lane ground truth HD map data (true lane map) and/or generated to simulated roadways and lanes that do not exist tin the real world (fictitious lane map) but for which simulated road boundaries and detected lanes can be generated. The recorded GPS path may include GPS data for different parts of a virtual path at which simulated lanes 254 and obstacles 258 are found at particular positions in HD ap 252. The user defined simulated lanes may include simulated lane detection data. Obstacles 258 may include data for simulated objects such as cars, trucks, pedestrians, animals, traffic lights, stop signs, and other objects. The data components 252-258, may be provided to combiner 211 either in combination with other data (e.g., to indicate a place on a map and the GPS location of the object) or by itself.

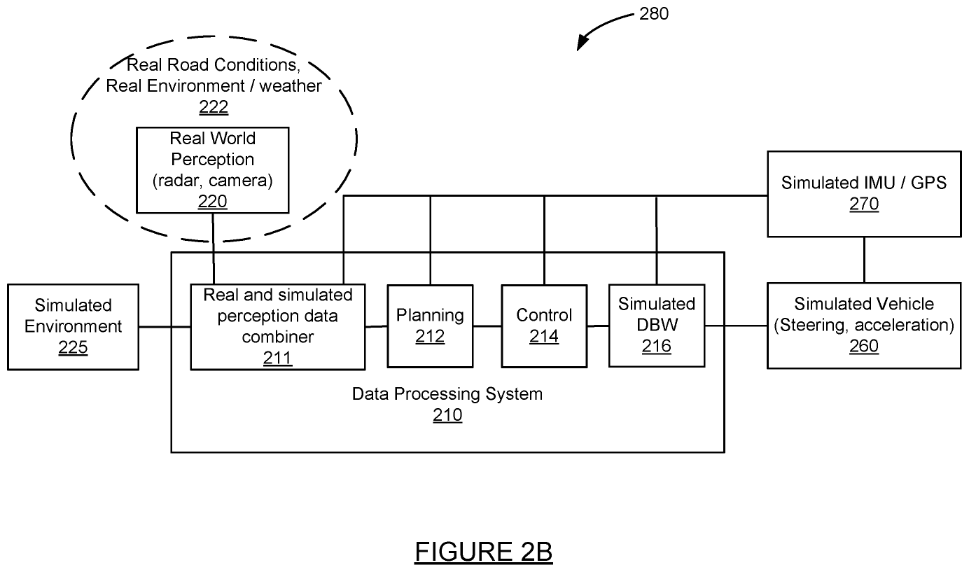

FIG. 3 is a method for operating an autonomous vehicle based on real world and virtual environment data. The autonomous vehicle is initialized at step 310. Initializing the autonomous vehicle may include starting the autonomous vehicle, performing an initial system check, calibrating the vehicle to the current ambient temperature and weather, and calibrating any systems as needed at startup.

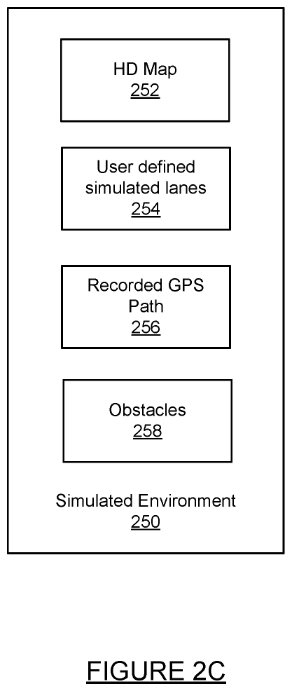

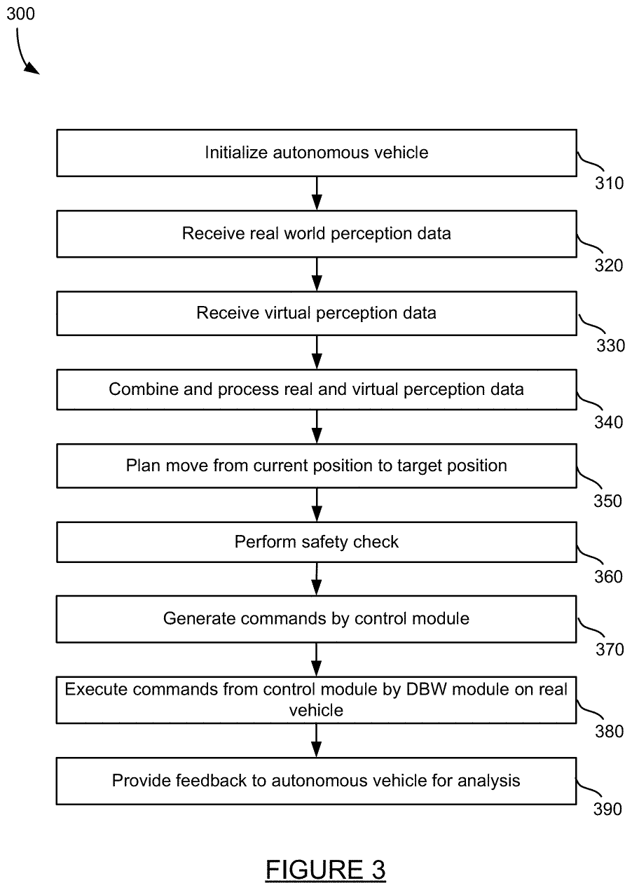

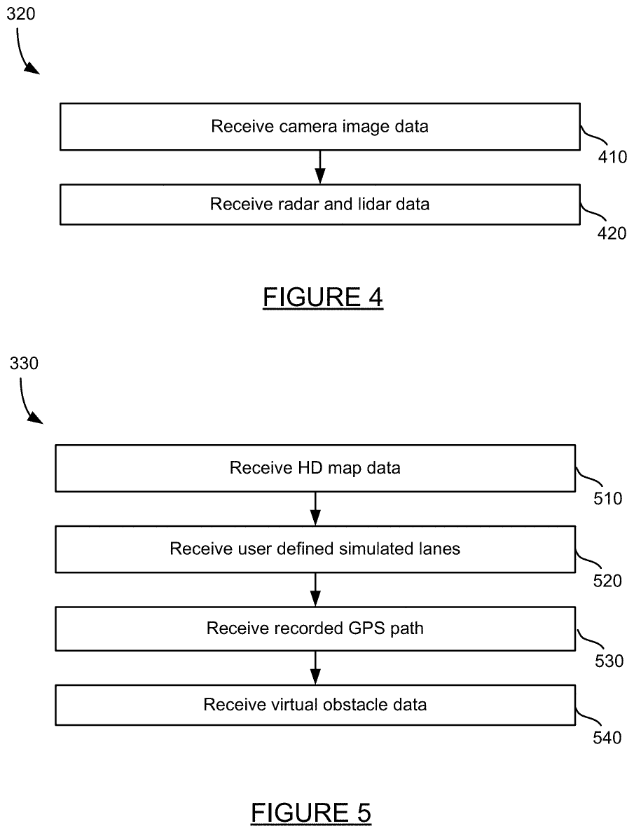

Real-world perception data is received at step 320. The real-world perception data may include data provided by real cameras, radar, lidar, and other perception sensors. More detail for receiving real-world data is discussed with respect to FIG. 4. Virtual perception data is received at step 330. The virtual perception data may include virtual objects, virtual lane detection data, and other virtual data, for example as discussed with respect to FIG. 2B. More detail for receiving virtual environment perception data is discussed with respect to FIG. 5. The virtual environment and real-world perception data are combined and processed to generate an object list and lane detection data at step 340. Perception data may include image data from one or more cameras, data received from one or more radars and lidar, and other data. The virtual environment and real-world perception data may be received by the combiner 211 and may be processed by logic associated with the combiner 211. Combining and processing the real-world perception data and the simulated environment data is discussed with respect to FIG. 6. Once the object list and lane detection data are generated, they are provided to the data processing system planning module.

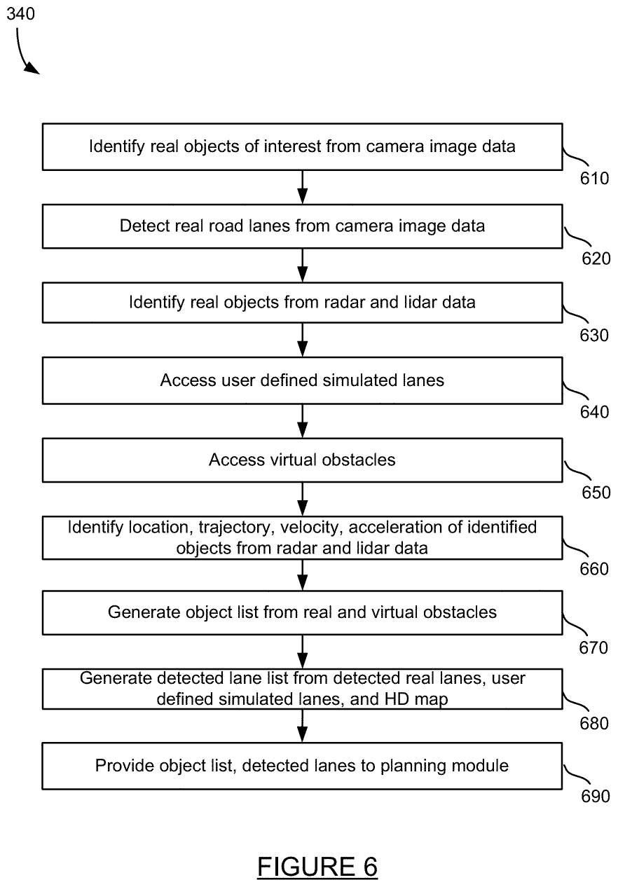

In response to receiving the object and lane detection data, the data processing system may plan a change from a current position to a target position at step 350. Planning a change from current position to target position may include generating a plurality of sampled trajectories, analyzing each trajectory to determine the best one, and selecting the best trajectory. More details for planning a change from a current position to target position is discussed with respect to the method of FIG. 7.

A safety check is performed at step 360. A safety check may include confirming all obstacles exist along the selected trajectory, no collisions will occur along the selected trajectory, and that the autonomous vehicle can physically navigate along the selected trajectory.

Once the planning module generates a selected trajectory and a safety check is performed, the trajectory line is provided to a control module. The control module generates commands to navigate the autonomous vehicle along the selected trajectory at step 370. The commands may include how and when to accelerate the vehicle, apply braking by the vehicle, and the angle of steering to apply to the vehicle and at what times. The commands are provided by the control module to the drive-by wire module for execution at step 380. The drive-by wire module may control the real autonomous vehicle brakes, acceleration, and steering wheel, based on the commands received from the control module. By executing the commands, the drive-by wire module makes the real autonomous vehicle proceed from a current position to a target position, for example along the selected trajectory from a center reference line of a current lane within a road to a center reference line in an adjacent lane, off ramp, on ramp, or other throughway.

Feedback is provided to the autonomous vehicle with respect to the planning and control of the vehicle based on the real-world and virtual environment perception data at step 390. The feedback can be used to compare the actual output with the expected output, which in turn can be used to tune the autonomous vehicle planning and command modules.

FIG. 4 is a method for receiving real-world perception data. The method of FIG. 4 provides more detail for step 320 of the method of FIG. 3. First, real-world camera image data is received at step 410. The camera image data may include images and/or video of the environment through which the autonomous vehicle is traveling. Real-world radar and lidar data are received at step 440. The radar and lidar data may be used to detect objects such as other vehicles and pedestrians on roads and elsewhere in the vicinity of the autonomous vehicle.

FIG. 4 is a method for receiving virtual environment perception data. The method of FIG. 4 provides more detail for step 330 of the method of FIG. 3. HD map data is received at step 510. User defined simulated lanes are received at step 520. A recorded GPS path is received at step 530, and virtual obstacle data is received at step 540.

FIG. 6 is a method for combining and processing real-world and virtual environment data. The method of FIG. 6 provides more detail for step 340 of the method of FIG. 3. Real objects of interest may be identified from a real camera image and/or video data at step 610. Objects of interest may include a stop light, stop sign, other signs, and other objects of interest that can be recognized and processed by the data processing system. In some instances, image data may be processed using pixel clustering algorithms to recognize certain objects. In some instances, pixel data may be processed by one or more machine learning models are trained to recognize objects within images, such as traffic light objects, stop sign objects, other sign objects, and other objects of interest.

Real road lanes are detected from real camera image data at step 620. Road lane detection may include identifying the boundaries of a particular road, path, or other throughway. The road boundaries and lane lines may be detected using pixel clustering algorithms to recognize certain objects, one or more machine learning models trained to recognize road boundary and lane line objects within images, or by other object detection methods.

Real radar and lidar data may be processed to identify real objects within the vicinity of the autonomous vehicle, such as between zero and several hundred feet of the autonomous vehicle, at step 630. The processed radar and lidar data may indicate the speed, trajectory, velocity, and location of an object near the autonomous vehicle. Examples of objects detectable by radar and lidar include cars, trucks, people, and animals.

User defined simulated lanes may be received at step 640 and virtual objects can be accessed at step 650. The location, trajectory, velocity, and acceleration of identified objects from radar and lidar data (real and virtual) is identified at step 660.

An object list of the real and virtual objects detected via radar, lidar, and objects of interest from the camera image data and virtual perception data is generated at step 670. For each object in the list, information may be included such as an identifier for the object, a classification of the object, location, trajectory, velocity, acceleration of the object, and in some instances other data such as whether the object is a real or virtual object. The object list, road boundaries, and detected lanes are provided to a planning module at step 480.

In some instances, simulated perception data may be generated to manipulate, alter, or otherwise complement a specific real-world perception data element. For example, if a real world object such as a car is detected in an adjacent lane, the simulated environment module 225 may receive the real world data element and, in response, generate one or more virtual perception elements (e.g., complimentary virtual perception elements) such as an artificial delay, an artificial history of movement to indicate a direction that the object may be heading in, artificial lights and/or sounds associated with the element (e.g., to make a normal real world car appear as a fire truck or ambulance), and other virtual elements. Simulated environment module 225 can receive real world perception data and generate simulated perception data to manipulate the real-world data. Through this manipulation process, the data processing system of the present technology can add variations in order to test many more cases and situations, especially corner cases than possible with real world data alone, and in a very efficient manner.

In some instances, the simulated environment module 225 may generate content that may not have a direct impact on the simulated perception for the vehicle's sensors, but may affect path planning. For example, a traffic condition simulation may be generated by simulated environment module 225 that includes content such as road work, a traffic jam, a dark traffic light, and so forth. These types of simulated content generated by the simulated environment module 225 may be used to test the planning module and control modules of the present system.

The result of combining real world perception data and simulated perception data is a collection of perception data that provides a much richer environment in which to train and tune the data processing system planning module and control module. For example, real world perception data may include a single lane road and simulated perception data may include two additional lanes with one or more virtual vehicles traveling in the real-world lane and virtual lanes. In another example, the real-world perception data may include a one-way road, and the virtual perception data may include a non-working traffic signal at a virtual cross street, to determine if the planning module can plan the correct action to take on the road based on the virtual element of the non-working traffic signal at the virtual cross street. The possible combinations of real-world perception data and simulated perception data is endless, and can be combined to provide a rich, flexible, and useful training environment. The real-world perception data and simulated perception data can be combined and fill in different voids for each other to tune and train a planning module and control module for an autonomous vehicle.

FIG. 7 is a method for planning a change from a current position to a target position. The method of FIG. 7 provides more detail for step 350 of the method of FIG. 3. For purposes of discussion, a move from a first lane to a second lane will be discussed, though other movements, such as moving from a first lane to a parking spot, can be performed in a similar manner.

A first center reference line for a current lane is generated at step 710. The first center reference line is generated by detecting the center of the current lane, which is detected from real or virtual camera image data. A turn signal is activated at step 720. A second center reference line is then generated at step 730. The second reference center line is a line at which the autonomous vehicle will be navigated to in an adjacent lane.

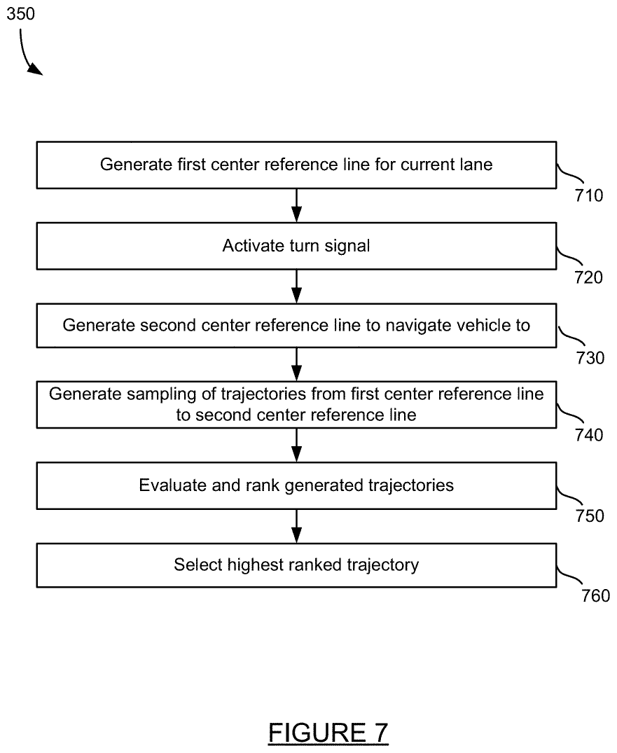

A sampling of trajectories from the center reference line in the current lane to the center reference line in the adjacent lane is generated at step 740. The sampling of trajectories may include a variety of trajectories from the center reference line in the present lane to various points along the center reference line in the adjacent lane reference line. Each generated trajectory is evaluated and ranked at step 750. Evaluating each trajectory within the plurality of sample trajectory lines includes determining objects in each trajectory, determining constraint considerations, and determining the cost of each trajectory. Evaluating and ranking the generated trajectories is discussed in more detail below with respect to the method of FIG. 8. The highest ranked trajectory is selected at step 760 and provided by the play module to the control module.

FIG. 8 is a method for evaluating and ranking generated trajectories. The method of FIG. 8 provides more detail for step 750 of the method of FIG. 7. For each factor in the ranking of a trajectory, the ranking is increased or decreased based on the outcome of a determination. For example, if a determination suggests that a trajectory may not be safe, the ranking may be cut in half or reduced by a certain percentage. In some instances, some determinations may have a higher weighting than others, such as for example objects detected to be in the particular trajectory.

Any objects determined to be in a trajectory are identified at step 810. When an object is determined to be in a particular trajectory, the ranking of that battery is reduced, in order to avoid collisions with the object while navigating the particular trajectory. Constraint considerations for each trajectory are determined at step 820. In some instances, one or more constraints may be considered for each trajectory. The constraints may include a lateral boundary, lateral offset, lateral speed, lateral acceleration, lateral jerk, and curvature of lane lines. Each constraint may increase or reduce the ranking of a particular trajectory based on the value of a constraint and thresholds associated with each particular constraint.

A cost of each sample trajectory is determined at step 830. Examples of costs include a terminal offset cost, average offset costs, lane change time duration cost, lateral acceleration costs, and lateral jerk cost. When determining a cost, the ranking may be decreased if a particular cost-a threshold or out of a range, and the ranking may be increased if the cost is below a threshold, or within a desired range. A score is assigned to each trajectory at step 840 based on analysis of the objects in the trajectory, constraints considered for the trajectory, and costs associated with each trajectory.

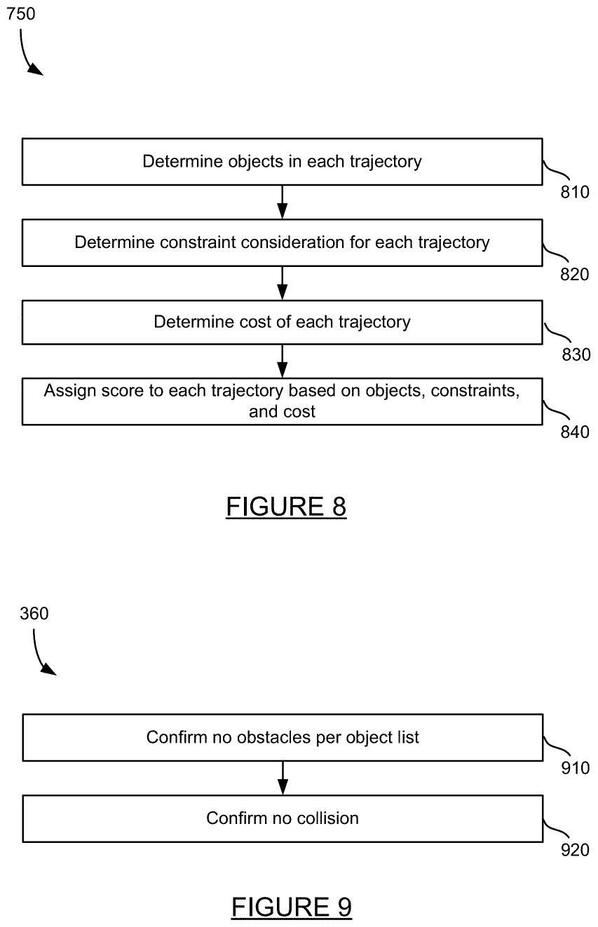

FIG. 9 is a method for performing a safety check. Performing a safety check for the method of FIG. 9 provides more detail for step 360 of the method of FIG. 3. First, the data processing system confirms that there are no obstacles along the selected trajectory at step 910. The system may confirm that the objects in the object list are not positioned in the trajectory as well as any new objects detected by radar, lidar, or camera data. A confirmation that no collisions will occur is performed at step 920. Collisions maybe detected to occur if an unexpected curvature in the road occurs, an unexpected boundary within a road is detected, or some other unforeseen obstacle appears in the selected trajectory.

The present technology combines real-world perception data and simulated environment perception data and processed the combined data to plan actions and control the autonomous vehicle to take the planned action. The virtual environment perception data may provide additional elements to the environment perceived and/or presented to the planning module.

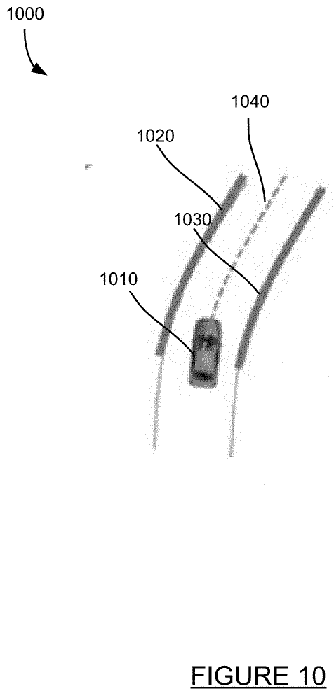

FIG. 10 illustrates a vehicle with elements determined from real-world perception data. As shown in FIG. 10, a vehicle 1010 detects real-world lane boundaries 1020 and 1030 and can generate a center reference line 1040 in the real-world lane.

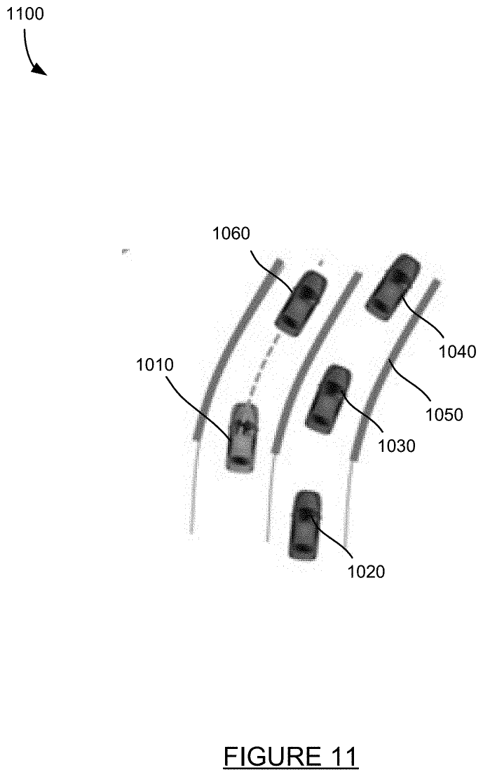

FIG. 11 illustrates the vehicle of FIG. 10 with elements determined from real-world perception data and virtual environment perception data. As shown in FIG. 11, in addition to the real-world lane boundaries, the virtual environment perception data includes virtual vehicle 1060 in the same lane as vehicle 1010 and virtual vehicles 1020, 1030, and 1040 in an adjacent virtual lane having a virtual boundary 1050. The planning module and control module process the real-world elements of FIG. 10 and the virtual elements of FIG. 11 in the same manner in order plan an action and control the vehicle 1010 to execute the plan.

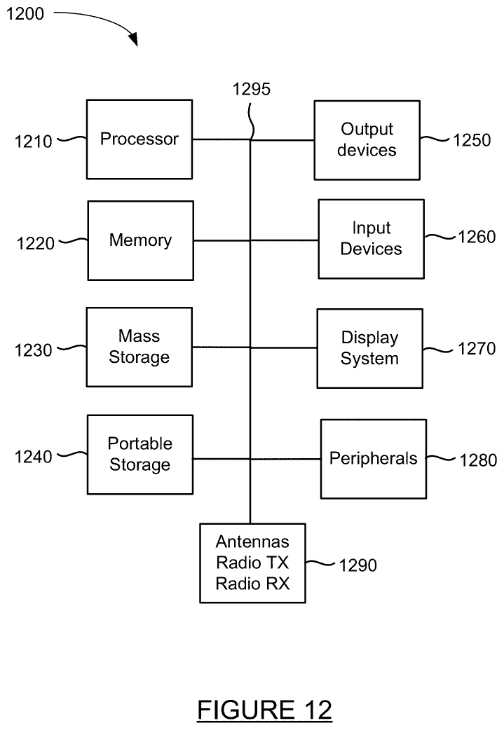

FIG. 12 is a block diagram of a computing environment for implementing a data processing system. System 1200 of FIG. 12 may be implemented in the contexts a machine that implements data processing system 125 on an autonomous vehicle. The computing system 1200 of FIG. 12 includes one or more processors 1210 and memory 1220. Main memory 1220 stores, in part, instructions and data for execution by processor 1210. Main memory 1220 can store the executable code when in operation. The system 1200 of FIG. 12 further includes a mass storage device 1230, portable storage medium drive(s) 1240, output devices 1250, user input devices 1260, a graphics display 1270, and peripheral devices 1280.

The components shown in FIG. 12 are depicted as being connected via a single bus 1290. However, the components may be connected through one or more data transport means. For example, processor unit 1210 and main memory 1220 may be connected via a local microprocessor bus, and the mass storage device 1230, peripheral device(s) 1280, portable storage device 1240, and display system 1270 may be connected via one or more input/output (I/O) buses.

Mass storage device 1230, which may be implemented with a magnetic disk drive, an optical disk drive, a flash drive, or other device, is a non-volatile storage device for storing data and instructions for use by processor unit 1210. Mass storage device 1230 can store the system software for implementing embodiments of the present technology for purposes of loading that software into main memory 1220.

Portable storage device 1240 operates in conjunction with a portable non-volatile storage medium, such as a flash drive, USB drive, memory card or stick, or other portable or removable memory, to input and output data and code to and from the computer system 1200 of FIG. 12. The system software for implementing embodiments of the present technology may be stored on such a portable medium and input to the computer system 1200 via the portable storage device 1240.

Input devices 1260 provide a portion of a user interface. Input devices 1260 may include an alpha-numeric keypad, such as a keyboard, for inputting alpha-numeric and other information, a pointing device such as a mouse, a trackball, stylus, cursor direction keys, microphone, touch-screen, accelerometer, wireless device connected via radio frequency, motion sensing device, and other input devices. Additionally, the system 1200 as shown in FIG. 12 includes output devices 1250. Examples of suitable output devices include speakers, printers, network interfaces, speakers, and monitors.

Display system 1270 may include a liquid crystal display (LCD) or other suitable display device. Display system 1270 receives textual and graphical information and processes the information for output to the display device. Display system 1270 may also receive input as a touch-screen.

Peripherals 1280 may include any type of computer support device to add additional functionality to the computer system. For example, peripheral device(s) 1280 may include a modem or a router, printer, and other device.

The system of 1200 may also include, in some implementations, antennas, radio transmitters and radio receivers 1290. The antennas and radios may be implemented in devices such as smart phones, tablets, and other devices that may communicate wirelessly. The one or more antennas may operate at one or more radio frequencies suitable to send and receive data over cellular networks, Wi-Fi networks, commercial device networks such as a Bluetooth device, and other radio frequency networks. The devices may include one or more radio transmitters and receivers for processing signals sent and received using the antennas.

The components contained in the computer system 1200 of FIG. 12 are those typically found in computer systems that may be suitable for use with embodiments of the present invention and are intended to represent a broad category of such computer components that are well known in the art. Thus, the computer system 1200 of FIG. 12 can be a personal computer, hand held computing device, smart phone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Android, as well as languages including Java, .NET, C, C++, Node.JS, and other suitable languages.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

1. A system for operating an autonomous vehicle based on real-world and virtual perception data, comprising:
a data processing system comprising one or more processors, memory, a planning module, and a control module, the data processing system to:
receive real-world perception data associated with a real-world object from real perception sensors;
receive simulated perception data;
generate a complimentary virtual perception element in response to receiving the real-world perception data from the real perception sensors, the complimentary virtual perception element manipulating an aspect of the detected real-world perception data;
combine the real-world perception data, complimentary virtual perception data and simulated perception data; and
generate a plan to control the vehicle based on the combined real-world perception data, complimentary virtual perception element, and simulated perception data, the vehicle operating in a real-world environment based on the plan generated from the real-world perception data, complimentary virtual perception element, and simulated perception data.

2. The system of claim 1, wherein manipulating the real-world object includes adding a variation to the real-world perception data through generating the complimentary virtual perception element.

3. The system of claim 1, wherein combine includes detecting real-world lane lines and virtual lane lines.

4. The system of claim 1, wherein the simulated perception data includes a recorded GPS path.

5. The system of claim 1, wherein the plan includes generating a plurality of trajectories, the trajectories extending between a real-world lane and a virtual lane.

6. The system of claim 1, wherein generate a plan includes planning an action based on a virtual object and a real-world object in the real-world environment.

7. The system of claim 1, the data processing system providing feedback to the autonomous vehicle after the plan is performed by the autonomous vehicle and tuning the autonomous vehicle based on the provided feedback.

8. The system of claim 7, wherein the feedback includes performance of a vehicle planning module and control module.

9. The system of claim 1, wherein the simulation data includes a high definition map.

10. The system of claim 9, wherein the high definition map includes simulated lanes forming a boundary on a road which the autonomous vehicle travels within, wherein the simulated lanes do not exist in the real world.

11. (canceled)

12. The system of claim 1, further comprising receiving a simulated traffic condition simulation, wherein the plan to the control the vehicle is generated at least in part on the received simulated traffic condition.

13. A system for testing a simulated autonomous vehicle based on real-world and virtual perception data, comprising:
a data processing system comprising one or more processors, memory, a planning module, and a control module, the data processing system to:
receive real-world perception data from real perception sensors;
receive simulated perception data;
generate a complimentary virtual perception element in response to receiving the real-world perception data from the real perception sensors, the complimentary virtual perception element manipulating an aspect of the detected real-world perception data;
combine the real-world perception data, complimentary virtual perception data and simulated perception data; and
generate a plan to control the simulated vehicle based on the combined real-world perception data, complimentary virtual perception element, and simulated perception data, the simulated vehicle operating in a simulated environment based on the plan generated from the real-world perception data, complimentary virtual perception element, and simulated perception data.

14. A non-transitory computer readable storage medium having embodied thereon a program, the program being executable by a processor to perform a method for operating an autonomous vehicle based on real-world and virtual perception data, the method comprising:
receiving real-world perception data from real perception sensors;
receiving simulated perception data;
generate a complimentary virtual perception element in response to receiving the real-world perception data from the real perception sensors, the complimentary virtual perception element manipulating an aspect of the detected real-world perception data;
combine the real-world perception data, complimentary virtual perception data and simulated perception data; and
generating a plan to control the vehicle based on the combined real-world perception data, complimentary virtual perception element, and simulated perception data, the vehicle operating in a real-world environment based on the plan generated from the real-world perception data, complimentary virtual perception element, and simulated perception data.

15. The non-transitory computer readable storage medium of claim 14, wherein manipulating the real-world object includes adding a variation to the real-world perception data through generating the complimentary virtual perception element.

16. The non-transitory computer readable storage medium of claim 14, wherein combine includes detecting real-world lane lines and virtual lane lines.

17. The non-transitory computer readable storage medium of claim 14, wherein the simulated perception data includes a recorded GPS path.

18. The non-transitory computer readable storage medium of claim 14, wherein the plan includes generating a plurality of trajectories, the trajectories extending between a real-world lane and a virtual lane.

19. The non-transitory computer readable storage medium of claim 14, wherein generate a plan includes planning an action based on a virtual object and a real-world object in the real-world environment.

20. The non-transitory computer readable storage medium of claim 14, the data processing system providing feedback to the autonomous vehicle after the plan is performed by the autonomous vehicle and tuning the autonomous vehicle based on the provided feedback.

21. The non-transitory computer readable storage medium of claim 20, wherein the feedback includes performance of a vehicle planning module and control module.

22. A method operating an autonomous vehicle based on real world and virtual perception data, comprising:
receiving, by a data processing system having modules stored in memory and executed by one or more processors, real-world perception data from real perception sensors;
receiving, by the data processing system, simulated perception data;
generate a complimentary virtual perception element in response to receiving the real-world perception data from the real perception sensors, the complimentary virtual perception element manipulating an aspect of the detected real-world perception data;
combine the real-world perception data, complimentary virtual perception data and simulated perception data; and
generating a plan to control the vehicle based on the combined real-world perception data, complimentary virtual perception data, and simulated perception data, the vehicle operating in a real-world environment based on the plan generated from the real-world perception data, complimentary virtual perception data, and simulated perception data.

23. The method of claim 22, wherein manipulating the real-world object includes adding a variation to the real-world object through generating the complimentary virtual perception element.

24. The method of claim 22, wherein combining includes detecting real-world lane lines and virtual lane lines.

25. The method of claim 22, wherein the simulated perception data includes a recorded GPS path.
